(19) United States
(12) Patent Application Publication
(10) Pub. No.: US 2008/0156437 A1
(43) Pub. Date: Jul. 3, 2008

(54) Method for Connecting Flexible Printed Circuit Board to Another Circuit Board

(76) Inventors: Kohichiro Kawate, Tokyo (JP); Yoshiaki Sato, Kanagawa (JP); Yuji Hirasawa, Kanagawa (JP)

Correspondence Address: 3M INNOVATIVE PROPERTIES COMPANY, PO BOX 33427, ST. PAUL, MN, 55133-3427, US

(21) Appl. No.: 11/816,124

(22) PCT Filed: Mar. 7, 2006
(86) PCT No.: PCT/US2006/007903

§ 371 Date: Aug. 13, 2007

(30) Foreign Application Priority Data
Mar. 7, 2005 (JP) 2005-061858

(51) Int. Cl. C09J 163/00

(52) U.S. Cl. 156/330

(57) ABSTRACT

A method for connecting FPC to a second circuit board, comprising the steps of (i) preparing a flexible printed circuit board (FPC) and a second circuit board, (ii) disposing the connection parts of the FPC to face the connection parts of the second circuit board such that a thermosetting adhesive film is present between the connection parts of the FPC and the connection parts of the second circuit board, and (iii) applying heat and pressure sufficiently high to thoroughly push away the adhesive film for establishing electrical contact and allow for curing of the adhesive, wherein the ratio of conductor width (L)/conductor-to-conductor distance (S) in the conductor wiring end parts constituting the connection parts of FPC is 0.5 or less and the thermosetting adhesive film is adjusted to have a viscosity of 500 to 20,000 Pa·s at 200° C.

### TECHNICAL FIELD

The present invention relates to a method for connecting a flexible printed circuit board (FPC) to another circuit board.

### BACKGROUND

In electronic devices such as digital camera, cellular phone and printer, a flexible circuit board (FPC) (hereinafter sometimes simply referred to as “FPC”) joined with another circuit board is used in many cases. These electronic devices are becoming small and the need for connecting FPC having a wiring at a fine pitch to another wiring board is increasing.

The connection of FPC to another circuit board has been conventionally performed by providing a solder bump on the connection part of FPC, and contacting and soldering the connection part to the electrode of another circuit board, thereby establishing the connection. However, the pitch between connection parts on FPC is becoming fine and as the pitch becomes finer, there arises a problem such as short-circuit between adjacent connection parts. Also, when the pitch is fine, the physical strength of the portion for connection is low and the connection stability is disadvantageously poor. Therefore, it is demanded to develop a method for connecting FPC to another circuit board, which is free from the problem of short-circuit and assures high reliability of connection.

With respect to conventional connection techniques for FPC, an anisotropically electroconductive film is long known (see, for example, Patent Documents 1 to 3 (Japanese Unexamined Patent Publication (Kokai) Nos. 51-29941, 51-21192 and 51-101040). According to this technique, a composition is prepared by adding electroconductive particles in a resin and the connection parts intended to mutually connect are superposed one on another through the composition and press-bonded under heat, whereby the connection parts are electrically joined with each other through the electroconductive particles in the composition. However, since an electroconductive particle is used, there is a risk of causing short-circuit in the case of connection of fine wirings.

### SUMMARY

An object of at least one embodiment of the present invention is to provide a method for connecting FPC to another circuit board, which is free from occurrence of short-circuit problem even at a fine pitch and assures high reliability of connection as compared with conventional methods of connecting FPC to another circuit board by soldering or by using an anisotropically electroconductive composition containing electroconductive particles.

In one embodiment, the present invention provides a method for connecting a flexible printed circuit board (FPC) to a second circuit board, comprising the steps of:

(i) preparing a flexible printed circuit board (FPC) having connection parts assigned to end parts of a plurality of conductor wirings, and a second circuit board having connection parts assigned to corresponding end parts of a plurality of conductor wirings, to which the FPC is connected,

(ii) disposing the connection parts of the FPC to face the connection parts of the second circuit board such that a thermosetting adhesive film is present between the connection parts of the FPC and the connection parts of the second circuit board, and

(iii) applying heat and pressure to the connection parts and the thermosetting adhesive film, sufficiently high to thoroughly push away the adhesive film for establishing electrical contact between connection parts of circuit boards facing each other and allow for curing of the adhesive,

wherein the ratio of conductor width (L)/conductor-to-conductor distance (S) in the conductor wiring end parts constituting the connection parts of the flexible circuit board is 0.5 or less and the thermosetting adhesive film is adjusted to have a viscosity of 500 to 20,000 Pa·s at 200° C.

The “second circuit board (second wiring board)” as used in the present invention is a concept including not only a normal circuit board but also the wiring board portion of a flattened terminal of an element having functionality (for example, piezoelectric element, temperature sensor or optical sensor).

The “viscosity of thermosetting adhesive film” is determined from the thickness (h(t)) of adhesive film when a thermosetting adhesive film sample having a radius a (m) is disposed between two horizontal plates and aged for a time period t (seconds) while applying a constant load F (N) at a measuring temperature T (° C.), and calculated according to the following formula: h(t)/ho=[(4 ho²Ft)/(3 πηa⁴)+1]^{-1/2} (wherein ho is an initial thickness (m) of thermosetting adhesive film, h(t) is a thickness (m) of adhesive film after t seconds, F is a load (N), t is a time period (seconds) passed after imposing the load F, η is a viscosity (Pa·s) at the measuring temperature T° C., and a is a radius (m) of thermosetting adhesive film).

In at least one embodiment of the present invention, unlike conventional connection of FPC to another board by soldering, these boards are connected with the intervention of an adhesive film between connection parts of respective boards and therefore, the problem of short-circuit does not arise even when the connection parts are arrayed at a fine pitch. Furthermore, the connection parts are supported and fixed by the adhesive film, so that the connection can be prevented from cancellation due to external stress and the connection reliability can be elevated. Moreover, the dimensional relationship between conductor width (L) and conductor-to-conductor distance (S) and the thermosetting adhesive film are specified as above, so that the connection parts can be unfailingly contacted with each other at the press bonding under heat and highly reliable connection can be obtained.

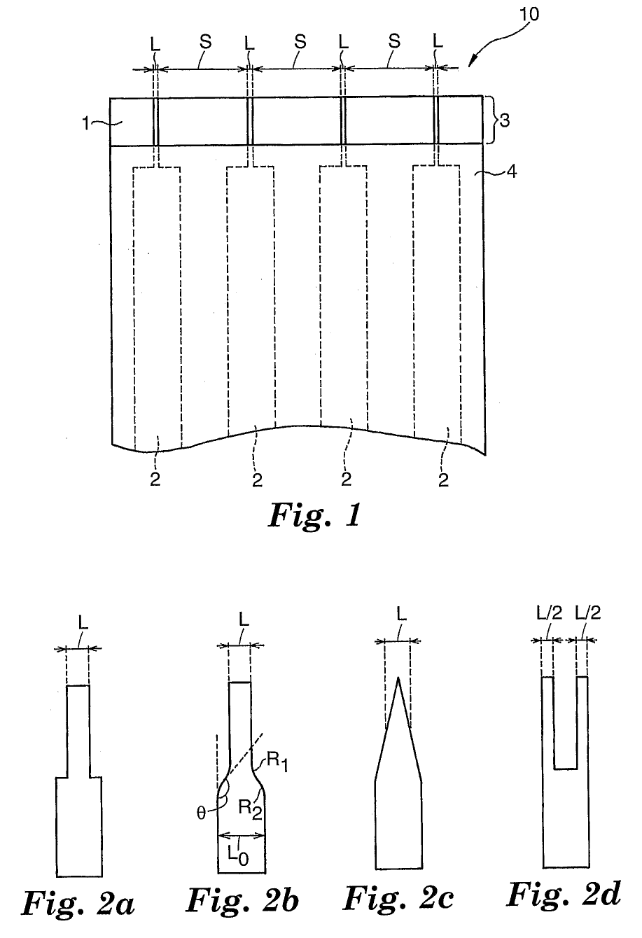

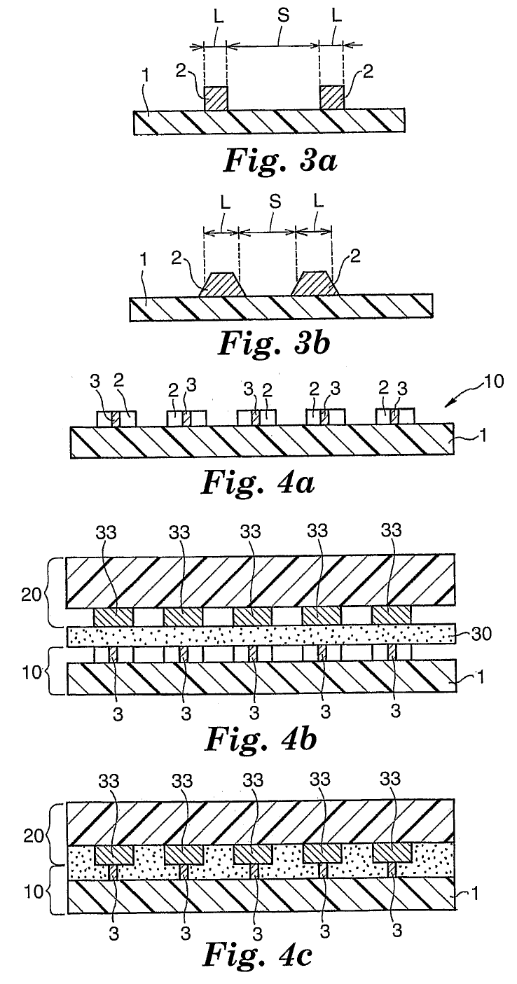

### BRIEF DESCRIPTION OF THE DRAWINGS

[FIG. 1] A perspective view showing the top surface in one embodiment of FPC usable in the method of the present invention.

[FIGS. 2a to 2d] Views showing several shapes in the connection part of the conductor wiring of FPC.

[FIGS. 3a to 3b] Cross-sectional views showing an embodiment of the conductor wiring in the connection part of FPC.

[FIGS. 4a to 4c] Views showing the process in the connection method of the present invention.

### DISCLOSURE

The present invention is described based on the following embodiment, but the present invention is not limited to this specific embodiment.

### Flexible Printed Circuit Board (FPC)

In the flexible printed circuit board (FPC) for use in the present invention, the ratio of conductor width (L)/conductor-to-conductor distance (S) in the conductor wiring end parts constituting the connection parts of FPC is 0.5 or less. Since the L/S in general is about 1, the L/S of FPC for use in the present invention is small. With a dimension in such a range, when the FPC is press-bonded under heat and thereby connected by using a specific thermosetting adhesive film for use in the present invention, good connection can be obtained. This is considered to result because as the ratio of conductor width (L)/conductor-to-conductor distance (S) is smaller, the pressure imposed on the thermosetting adhesive film becomes higher and it is more facilitated to push away the thermosetting adhesive film and establish contact between the connection part of FPC and the connection part of a second circuit board. From this standpoint, the ratio of conductor width (L)/conductor-to-conductor distance (S) is preferably 0.3 or less, more preferably 0.2 or less. The present invention is described below by referring to the drawings.

FIG. 1 is a perspective view showing the top surface of FPC 10 comprising a resin film 1 having provided on the front surface thereof wirings 2 with the end parts working as connection parts 3. Usually, the portions except for the connections parts 3 are covered with an insulating film 4 so as to ensure electric insulation. In the Figure, L is a conductor width and S is a conductor-to-conductor distance. As shown, the conductor width (L) can be made smaller than the width in other portions of the conductor wiring. With such a constitution that the conductor width (L) is small only in the end part, the strength of conductor wiring except for the connection part can be ensured. As the conductor width (L) is smaller, the connection parts of FPC can be more easily contacted with the connection parts of a second circuit board at the press bonding under heat. Also, after the press bonding under heat, the connection parts are fixed by the adhesive film and therefore, the connection reliability in the connection step can also be ensured. However, in order to withstand the stress imposed at the press bonding under heat, the conductor width (L) is preferably at least 10 μm or more. Also, as the thickness of conductor is larger, the contact of the connections parts of FPC to a second circuit board is facilitated. However, if the thickness of the conductor wiring is excessively large, the resistance of FPC against bending stress decreases and wire breakage readily occurs. From such a standpoint, the thickness of the conductor is preferably from 9 to 35 μm.

FIG. 2 shows some embodiments of the shape in the connection part of conductor wiring of FPC. In FIGS. 2(a) to 2(d), the conductor width (L) of conductor wiring in the connection part is smaller than in other portions of the conductor wiring so as to achieve the above-described ratio of conductor width (L)/conductor-to-conductor distance (S). The conductor width (L) is considered to be an average width in the contact portions when the connection parts are joined with connection parts of a second circuit board. The conductor wiring in the connection part is not limited in the modes and can take various modes other than those shown in the Figures. However, a shape difficult of wire breakage should be selected for the portion reducing in the conductor width, because bending stress and thermal stress are sometimes generated therein. For example, in the case of having a curved shape as shown in FIG. 2(b), the concentration of stress can be prevented and therefore, wire breakage scarcely occurs. In the shape of FIG. 2(b), for example, when L=0.3° L₀ (wherein Lₒ is a conductor width of unreduced conductor and L is a conductor width of reduced conductor) and when the radius R₁ or R₂ of curvature in the reducing portion is L and the inclination angle θ is about 120°, wire breakage is difficult to occur. More specifically, for example, a shape where L₀ is 100 μm, L is 30 μm, the radius R₁ or R₂ of curvature in the reducing portion is 30 μm and the inclination angle θ is 120° is preferred.

FIG. 3 is a cross-sectional view showing the embodiment of the conductor wiring in the connection part. On the front surface of a resin film 1, conductor wirings 2 are disposed. The cross-section of the conductor wiring has, as shown in FIG. 3(a), a rectangular or square shape or, as shown in FIG. 3(b), may have a trapezoidal or triangular shape tapered toward the top end. In the case of cross-section having a trapezoidal or triangular shape, L is an average width in the height direction and S is a pitch between wirings (that is, distance between centers in the longitudinal direction of conductor wirings)−L.

The material for the conductor wiring may be a conductor such as solder (e.g., Sn—Ag—Cu), copper, nickel and gold. Also, in view of connecting property, the surface may be finished, for example, by plating a material such as tin, gold, nickel and nickel/gold alloy. The substrate of FPC may be a resin film usually used for FPC, such as polyimide film.

### Second Circuit Board

The second circuit board to which the flexible circuit board (FPC) for use in the present invention is connected may be any appropriate circuit board such as glass epoxy based circuit board, aramid based circuit board, bismaleimide-triazine (BT resin) based circuit board, glass or ceramic board having thereon a wiring pattern formed of ITO or metal fine particle, rigid circuit board (e.g., silicon wafer) having on the surface thereof junction part of metal conductor, and flexible circuit board including lead-type or via-type FPC.

### Method for Connection of FPC to Second Circuit Board

The FPC connection method of the present invention is described in the order of steps. First, a flexible printed circuit board (FPC) 10 comprising a resin film 1 having formed thereon conductor wirings 2 is prepared (step (a)). Thereafter, a second circuit board 20 to which this FPC 10 is connected is prepared, and the connection parts 3 of FPC 10 and the connection parts 33 of the second circuit board 20 are aligned and superposed one on another through a thermosetting adhesive film 30 (step (b)). The resulting stacked body of these superposed FPC 10, thermosetting adhesive film 30 and second circuit board 20 is press-bonded under heat to establish electrical connection between the connection parts 3 of FPC 10 and the connection parts 33 of the second circuit board 20 (step (c)). The thermosetting adhesive film 30 may comprises two or more strips, and each strip may be preliminarily heat-laminated on the connection parts of FPC 10 or second circuit board 20 to provide intervals between respective strips and run across a plurality of conductor wirings. In this case, when the thermosetting adhesive film 30 is pushed away at the press-bonding under heat, the excess adhesive is caused to fill the space between respective strips and the adhesive can be prevented from running out of the connection portion.

The press-bonding under heat can be performed by a heat bonder capable of applying heat and pressure, such as pulse heat bonder and ceramic heat bonder. In using the heat bonder, a heat-resistant elastic sheet such as polytetrafluoroethylene (PTFE) film or silicone rubber is preferably inserted between the FPC or second circuit board and the bonder head. When an elastic sheet is inserted, the resin film of FPC is pushed at the press-bonding under heat and a stress (spring back) is generated due to deflection of the resin film. The resin film holds the deflected state after the curing of adhesive film, whereby the contact pressure is maintained and the connection stability is elevated.

The press-bonding under heat is performed by compressing the stacked body with a heated plate. The temperature and pressure at the press-bonding under heat are not limited and these are determined according to the resin composition or the like of the adhesive film selected. In the present invention, an adhesive film which is softened at 100° C. or more and cured at about 150 to 250° C. is generally preferred. At the time of preliminarily heat-laminating the adhesive film on FPC, the press-bonding under heat is performed at a heating temperature of about 150 to 230° C. for a heating time of 1 to 10 seconds under an applied pressure of 5 to 200 N/cm². By this treatment, the adhesive film is softened and bonded to FPC but the curing thereof slightly proceeds and the thermosetting property is maintained. At the time of connecting FPC to the second circuit board, the press-bonding under heat is performed to effect the curing at a temperature of 150 to 250° C. for from 1 second to several minutes under an applied pressure of 5 to 200 N/cm².

The thermosetting adhesive film for use in the present invention is described below. In the present invention, a thermosetting adhesive film containing a resin capable of being softened when heated at a certain temperature and being cured when further heated is used. The resin having such softening and thermosetting properties is a resin containing both a thermoplastic component and a thermosetting component. In a first embodiment, the thermosoftening and thermosetting resin may be a mixture of a thermoplastic resin and a thermosetting resin. In a second embodiment, the thermosoftening and thermosetting resin may be a thermosetting resin modified with a thermoplastic component. Examples of the second embodiment includes a polycaprolactone-modified epoxy resin. In a third embodiment, the thermosoftening and thermosetting resin may be a polymer resin having a thermosetting group such as epoxy group in the basic structure of a thermoplastic resin. Examples of such a polymer resin include a copolymer of ethylene and glycidyl (meth)acrylate.

The thermosetting adhesive film which can be used in the present invention is a thermosetting adhesive film having a viscosity of 500 to 20,000 Pa·s at a temperature of 200° C. The “viscosity of thermosetting adhesive film” is determined from the thickness (h(t)) of adhesive film when a thermosetting adhesive film sample having a radius a (m) is disposed between two horizontal plates and aged for a time period t (seconds) while applying a constant load F (N) at a measuring temperature T (0° C.), and calculated according to the following formula: h(t)/ho=[(4 ho²Ft)/(3 πηa⁴)+1]^{-1/2} (wherein ho is an initial thickness (m) of thermosetting adhesive film, h(t) is a thickness of adhesive film after t seconds, F is a load (N), t is a time period (seconds) passed after imposing the load F, η is a viscosity (Pa·s) at the measuring temperature T° C., and a is a radius (m) of thermosetting adhesive film).

In the present invention, the viscosity is specified to fall within the above-described range because of the following reasons. When the viscosity at 200° C. is 500 Pa·s or more, the adhesive film can have a sufficiently high viscosity at the short-time press-bonding under heat at 150 to 250° C., a stress (spring back effect) owing to deflection of resin film of FPC can be obtained as described above, and the connection stability can be maintained. For example, when the resin film is a 25 μm-thick polyimide film and when the viscosity of the adhesive film is 500 Pa·s or more at 200° C., good connection stability is obtained. If the viscosity of the adhesive film is too high, the resin can be hardly pushed away from between wired conductors in the connection part even when a high pressure is applied. When the viscosity of the adhesive film is 20,000 Pa·s or less at 200° C., the connection between conductors can be established by the press-bonding under heat at a pressure described above. For forming a thermoplastic adhesive film having a viscosity within the above-described range, it is effective to partially cure an adhesive containing a curable resin to a B-stage.

In particular, the thermosetting adhesive composition which can be suitably used for the adhesive film is a thermosetting adhesive composition containing a caprolactone-modified epoxy resin. Such a thermosetting adhesive composition usually has a crystal phase. In at least one embodiment, this crystal phase comprises a caprolactone-modified epoxy resin (hereinafter sometimes referred to as a “modified epoxy resin”) as the main component. The modified epoxy resin can impart appropriate flexibility to the thermosetting adhesive composition and thereby improve the viscoelastic property of the thermosetting adhesive. By virtue of this effect, the thermosetting adhesive can be made to have cohesive force even before curing and express adhesive strength under heat. Furthermore, this modified epoxy resin becomes a cured product having a three-dimensional network structure when heated, similarly to normal epoxy resin, and can impart cohesive force to the thermosetting adhesive.

From the standpoint of enhancing the initial adhesive force, the modified epoxy resin usually has an epoxy equivalent of about 100 to about 9,000, preferably from about 200 to about 5,000, more preferably from about 500 to about 3,000. The proper modified epoxy resin having such an epoxy equivalent is commercially available, for example, from Daicel Chemical Industries, Ltd. under the trade designation of Placcel G Series (for example, G402).

The thermosetting adhesive composition preferably contains a melamine/isocyanuric acid adduct (hereinafter sometimes referred to as a “melamine/isocyanuric acid complex”) in combination with the above-described modified epoxy resin. The useful melamine/isocyanuric acid complex is commercially available, for example, from Nissan Chemicals Industries, Ltd. under the trade designation of MC-600 and this is effective for toughening the thermosetting adhesive composition, less permitting the thermosetting adhesive composition to cause tack due to expression of thixotropy before heat curing, and inhibiting moisture absorption and fluidity of the thermosetting adhesive composition. In order to prevent embrittlement after curing without impairing these effects, the thermosetting adhesive composition may contain the melamine/isocyanuric acid complex in an amount of usually from 1 to 200 parts by mass, preferably from 2 to 100 parts by weight, more preferably from 3 to 50 parts by weight, per 100 parts by weight of the modified epoxy resin.

The thermosetting adhesive composition has strength sufficiently high to connect FPC in normal use and moreover can be cured such that the cured product can be softened when heated. This is possible because the curing of a thermosetting adhesive can be effected in a controlled way.

In the case of using a caprolactone-modified epoxy resin as the thermosetting resin, the thermosetting adhesive composition may further contain a thermoplastic resin so as to enhance the repair property. The “repair property” means an ability such that after the completion of connection, the adhesive film can be peeled off under heat and again the connection can be performed. In the present invention, after connecting a flexible printed circuit board (FPC) to a second circuit board, the FPC and second circuit board are separated at a temperature of 120 to 200° C. and the connection step is again repeated, whereby the repair property can be exerted. The thermoplastic resin which can be used here is suitably a phenoxy resin. The phenoxy resin is a thermoplastic resin having a chained or linear structure and a relative high molecular weight and is formed from epichlorohydrin and bisphenol A. This phenoxy resin has high processability and facilitates the processing of the thermosetting adhesive composition into an adhesive film. According to one embodiment of the present invention, the thermosetting adhesive composition contains the phenoxy resin in an amount of usually from 10 to 300 parts by weight, preferably from 20 to 200 parts by weight, per 100 parts by weight of the modified epoxy resin. This is because the phenoxy resin can be effectively compatibilized with the modified epoxy resin and in turn, the modified epoxy resin can be effectively prevented from bleeding out from the thermoplastic adhesive composition. Furthermore, the phenoxy resin can intertwine with the cured product of the above-described modified epoxy resin to more enhance the final cohesive force, heat resistance and the like of the thermosetting adhesive layer.

In combination with or independently of the above-described phenoxy resin, the thermosetting adhesive composition may further contain a second epoxy resin (hereinafter sometimes simply referred to as an “epoxy resin”), if desired. This epoxy resin is not particularly limited as long as the scope of the present invention is observed. Examples of the epoxy resin which can be used include bisphenol A-type epoxy resin, bisphenol F-type epoxy resin, bisphenol A diglycidyl ether-type epoxy resin, phenol novolak-type epoxy resin, cresol novolak-type epoxy resin, fluorene epoxy resin, glycidyl amine resin, aliphatic epoxy resin, bromated epoxy resin and fluorinated epoxy resin. Such an epoxy resin is readily compatibilized with the phenoxy resin similarly to the modified epoxy resin and scarcely bleeds out from the thermoplastic adhesive composition. In particular, the thermosetting adhesive composition preferably contains the second epoxy resin in an amount of 50 to 200 parts by weight, more preferably from 60 to 140 parts by weight, per 100 parts by weight of the modified epoxy resin, and this is advantageous from the standpoint of enhancing the heat resistance.

In practicing the present invention, particularly a bisphenol A diglycidyl ether-type epoxy resin (hereinafter sometimes referred to as a “diglycidyl ether-type epoxy resin”) is preferably used as the second epoxy resin. This diglycidyl ether-type epoxy resin is in a liquid state and can improve, for example, high-temperature properties of the thermosetting adhesive composition. For example, when the diglycidyl ether-type epoxy resin is used, the chemical resistance or glass transition temperature in the curing at a high temperature can be improved. Also, curing agents over a wide range can be applied and the curing conditions are relatively mild. Such a diglycidyl ether-type epoxy resin is commercially available, for example, from Dow Chemical (Japan) under the trade designation of D.E.R. 332.

In the thermosetting adhesive composition, a curing agent may be added, if desired, and used for the curing reaction of the epoxy resin. The curing agent is not particularly limited in its amount used and kind as long as desired effects can be provided, but from the standpoint of enhancing the heat resistance, the curing agent is usually contained in an amount of 1 to 50 parts by weight, preferably from 2 to 40 parts by weight, more preferably from 5 to 30 parts by weight, per 100 parts by weight in total of the epoxy resins. Examples of the curing agent which can be used include, but are not limited to, an amine curing agent, an acid anhydride, a dicyandiamide, a cationic polymerization catalyst, an imidazole compound and a hydrazine compound. Among these, a dicyandiamide is a promising curing agent because it has thermal stability at room temperature. Also, for use in the present invention, a fluorene amine curing agent is particularly useful in view of adhesive force at a high temperature of the adhesive film after curing. The fluorene amine curing agent is available, for example, from Nippon Steel Chemical Co., Ltd. under the trade designation of BAFL.

In the thermosetting adhesive composition, an organic particle can be added in an amount of 15 to 100 parts by weight per 100 parts by weight of the adhesive composition. By the addition of an organic particle, while the resin exhibits plastic fluidity, the organic particle maintains the flexibility after curing of the thermoplastic adhesive composition. Also, the heating in the connection step may cause evaporation of the moisture attached to FPC or second circuit board to incur activity of a water vapor pressure, but even in such a case, the resin is prevented from flowing and confining an air bubble.

Examples of the organic particle added include particles of acrylic resin, styrene-butadiene-based resin, styrene-butadiene-acrylic resin, melamine resin, melamine-isocyanurate adduct, polyimide, silicone resin, polyetherimide, polyethersulfone, polyester, polycarbonate, polyether ether ketone, polybenzimidazole, polyarylate, liquid crystal polymer, olefin-based resin and ethylene-acryl copolymer. The size of the particle is 10 μm or less, preferably 5 μm or less.

### EXAMPLE

### Example

The composition shown in Table 1 below was coated on a silicone-treated polyester film and dried to form a film having a thickness of 30 μm.

[Table 1]

TABLE 1
Resin Composition

| Component | Parts by Weight |
|---|---|
| YP50S | 30 |
| DER332 | 34 |
| G402 | 30 |
| BAFL | 16.4 |
| MC600 | 20 |
| EXL2314 | 80 |
| THF | 600 |

Phenoxy resin: YP50S, produced by Tohto Kasei Co., Ltd., number average molecular weight: 11,800
Epoxy resin: DER332, produced by Dow Chemical Japan Ltd., epoxy equivalent: 174
Polycaprolactone-modified epoxy resin: G402, produced by Daicel Chemical Industries, Ltd., epoxy equivalent: 1,350
Bis-aniline fluorene: BAFL, Nippon Steel Chemical Co., Ltd.
Melamine isocyanuric acid complex: MC-600, produced by Nissan Chemicals Industries, Ltd.
Acryl particle: EXL2314, KUREHA PARALOID EXL, produced by Kureha Chemical Industry Co., Ltd.
THF: tetrahydrofuran

The film formed was heat-treated at 100° C. by variously changing the treating time, and the viscosity at 200° C. of the films prepared was measured. The viscosity was measured as follows. The adhesive film sample was cut into a circular shape having a radius a (m) (0.005 m), the obtained thermosetting adhesive film sample was disposed between two horizontal plates and aged for a time period t (seconds) while applying a constant load F (N) (650 N) at 200° C., and the viscosity was calculated according to the following formula: h(t)/ho=[(4 ho²Ft)/(3 πηa⁴)+1]^{-1/2} (wherein ho is an initial thickness (m) of thermosetting adhesive film, h(t) is a thickness (m) of adhesive film after t seconds, F is a load (N), t is a time period (seconds) passed after imposing the load F, q is a viscosity (Pa·s) at the measuring temperature T° C., and a is a radius (m) of thermosetting adhesive film).

The results are shown in Table 2 below.

TABLE 2
Viscosity of Adhesive Film after Heat Treatment

| Heat-Treating Time (min) | Viscosity at 200° C. (Pa · s) |
|---|---|
| 55 | 1,170 |
| 60 | 1,870 |
| 62 | 2,390 |
| 65 | 4,360 |
| 67 | 8,600 |
| 70 | 14,100 |
| 75 | 25,500 |
| 80 | 38,800 |
| 90 | 55,000 |

An FPC (ESPANEX (trade designation) available from Nippon Steel Chemical Co., Ltd.) was prepared, where conductor wirings (nickel having thereon gold plating) were formed on a 25 μm-thick polyimide film such that the pitch between conductors was 0.5 mm, the conductor width was 0.05 mm (that is, the conductor-to-conductor distance (S) was 0.45 mm, the conductor width (L) was 0.05 mm, and the conductor width (L)/conductor-to-conductor distance (S) was 0.11) and the conductor thickness was 18 μm. Separately, a glass epoxy substrate where the pitch between conductors was 0.5 mm, the conductor width was 0.3 mm and the conductor thickness was 18 μm was prepared as a second circuit board. The glass epoxy substrate had 64 conductor wirings thereon, and respective two adjacent wirings were paired and electrically conducted. Also, FPC had 64 conductor wirings thereon, and respective two adjacent conductor wirings were paired and electrically conducted.

These FPC and glass epoxy substrate were superimposed one on another through the adhesive film prepared above by heat treatment at 100° C. for 60 minutes. This stacked body of FPC/adhesive film/glass epoxy substrate was press-bonded under heat and thereby connected to establish connection in series at 64 connection points. At this connection, Pulse Bonder TCW-215/NA-66 (available from Nippon Avionics Co., Ltd.) was used and the heat-bonding under heat was performed for 5 seconds at a head temperature of 220° C. with a load of 100 N. The resistance value of the sample after joining was measured (initial value: 8.02 ohm). Subsequently, the sample was charged into an oven at a temperature of 85° C. and a humidity of 85% for 1,000 hours, thereby effecting accelerated aging, and then the resistivity was again measured. As a result, the increase of the resistance value was within 2% of the initial value and it was verified that good connection was established.

1. A method for connecting a flexible printed circuit board (FPC) to a second circuit board, comprising the steps of:
(i) preparing a flexible printed circuit board (FPC) having connection parts assigned to end parts of a plurality of conductor wirings, and a second circuit board having connection parts assigned to corresponding end parts of a plurality of conductor wirings, to which said FPC is connected,
(ii) disposing the connection parts of said FPC to face the connection parts of said second circuit board such that a thermosetting adhesive film is present between the connection parts of said FPC and the connection parts of said second circuit board, and
(iii) applying heat and pressure to said connection parts and said thermosetting adhesive film, sufficiently high to thoroughly push away the adhesive film for establishing electrical contact between connection parts of circuit boards facing each other and allow for curing of the adhesive,
wherein the ratio of conductor width (L)/conductor-to-conductor distance (S) in the conductor wiring end parts constituting the connection parts of said flexible circuit board is 0.5 or less and said thermosetting adhesive film is adjusted to have a viscosity of 500 to 20,000 Pa·s at 200° C.

2. The method as claimed in claim 1, wherein the conductor width (L) in the end part of conductor wiring is smaller than the conductor width of other portions.

3. The method as claimed in claim 1, wherein said thermosetting adhesive film comprises a caprolactone-modified epoxy resin.

4. The method as claimed in claim 3, wherein said thermosetting adhesive film is adjusted to have a viscosity of 500 to 20,000 Pa·s at 200° C. by preliminarily heat-treating a thermosetting resin containing a caprolactone-modified epoxy resin.

5. The method as claimed in claim 3, wherein said thermosetting adhesive film comprises a fluoreneamine-based curing agent.

6. The method as claimed in claim 1, wherein the surface of the conductor wiring constituting the connection part of said FPC is tin, gold, nickel or a nickel/gold alloy.

7. The method as claimed in claim 1, wherein said thermosetting adhesive film comprises two or more strips and each strip is heat-laminated on the connection parts of the flexible printed circuit board (FPC) or second circuit board to provide intervals between respective strips and run across said plurality of conductor wirings.

8. The method as claimed in claim 1, wherein the connection is performed at a temperature of 150 to 200° C.

9. The method as claimed in claim 8, wherein said flexible printed circuit board (FPC) and second circuit board are separated at a temperature of 120 to 200° C. after connecting said FPC to said second circuit board and then the steps (ii) and (iii) are again repeated.
